(19) United States
(12) Patent Application Publication
(10) Pub. No.: US 2026/0141492 A1
(43) Pub. Date: May 21, 2026

(54) RENDERING METHOD AND DEVICE

(71) Applicant: SAMSUNG ELECTRONICS CO., LTD., Suwon-si (KR)

(72) Inventors: Hanjun KIM, Suwon-si (KR); Nahyup KANG, Suwon-si (KR); Hwiryong JUNG, Suwon-si (KR); Seokpyo HONG, Suwon-si (KR)

(73) Assignee: SAMSUNG ELECTRONICS CO., LTD., Suwon-si (KR)

(21) Appl. No.: 19/174,668

(22) Filed: Apr. 9, 2025

(30) Foreign Application Priority Data
Nov. 19, 2024 (KR) 10-2024-0165381

(51) Int. Cl. G06T 5/70; G06T 5/20; G06V 10/60; G06V 10/764

(52) U.S. Cl. CPC G06T 5/70; G06T 5/20; G06V 10/60; G06V 10/764; G06T 2207/20084; G06T 2207/20132

(57) ABSTRACT

A rendering method, including: based on information about a plurality of lights included in a rendered scene corresponding to a view associated with a camera, classifying the plurality of lights according to a plurality of light types; generating an input texture corresponding to each light type from among the plurality of light types; generating a shadow mask configured to reduce shadow noise included in a shadow corresponding to each light type by applying the input texture to a neural network model; and reducing the shadow noise from the rendered scene using the shadow mask.

### CROSS-REFERENCE TO RELATED APPLICATION

This application is based on and claims priority under 35 U.S.C. § 119 to Korean Patent Application No. 10-2024-0165381, filed on Nov. 19, 2024, in the Korean Intellectual Property Office, the disclosure of which is incorporated by reference herein in its entirety.

### BACKGROUND

### 1. Field

The present disclosure relates to a rendering method and device.

### 2. Description of the Related Art

In graphics rendering, casting shadows from a light may be referred to as “shadowing”. Shadowing may be used to render realistic scenes by providing a sense of distance and space to the scene. Rasterization is a graphics rendering technique which may use a shadow mapping method, but this may provide unrealistic shadowing and may have various unintended side effects such as a peter-panning phenomenon.

Although various methods have been developed to replace this shadow mapping method, there are limitations in rendering natural and realistic scenes while maintaining real-time performance.

### SUMMARY

One or more embodiments may address at least the problems and/or disadvantages described above, and other disadvantages not described above. Also, the embodiments are not required to overcome and may not overcome any of the problems and disadvantages described above.

In accordance with an aspect of the disclosure, a rendering method includes: based on information about a plurality of lights included in a rendered scene corresponding to a view associated with a camera, classifying the plurality of lights according to a plurality of light types; generating an input texture corresponding to each light type from among the plurality of light types; generating a shadow mask configured to reduce shadow noise included in a shadow corresponding to each light type by applying the input texture to a neural network model; and reducing the shadow noise from the rendered scene using the shadow mask.

The generating of the input texture may include, based on luminances of lights classified as a same light type from among the plurality of lights, generating a single input texture corresponding to the lights.

The generating of the input texture may further include: calculating luminances of the lights; and generating the single input texture using a weighted sum based on the luminances.

The weighted sum may be determined based on visibility textures and blur radius textures, and the luminances may be calculated by applying, to the weighted sum, a luminance corresponding to each of the lights.

The luminances may be calculated based on a light distance corresponding to each of the lights.

A directional light may be classified as corresponding to a first light type, and a non-directional light may be classified as corresponding to a second light type different from the first light type.

Weights of the weighted sum may be assigned according to the light distance corresponding to each of the lights.

The method may further include determining whether a plurality of predetermined light types include a missing light type that is missing from the plurality of light types corresponding to the plurality of lights included in the rendered scene, wherein the generating of the shadow mask may include, based on determining that the missing light type is missing from the plurality of light types, generating a dummy output corresponding to the shadow mask and a black dummy texture corresponding to each light type by applying the black dummy texture corresponding to the missing light type to the neural network model together with the input texture.

A number of input channels included in the neural network model may be proportional to a predetermined number of the plurality of light types.

The neural network model may be trained to generate a shadow mask corresponding to each light type regardless of a change in at least one of a number of the plurality of light types, a number of the plurality of lights, and an order of the lights caused by a change in the view associated with the camera in the rendered scene.

The rendered scene may include at least one of: a visibility texture corresponding to the plurality of lights; a blur radius texture indicating a size of a penumbra corresponding to a blur level caused by a shadow generated by the plurality of lights; history information associated with accumulated shadow rays, wherein the history information may include temporal information corresponding to previous frames of the rendered scene; and light distance information corresponding to the plurality of lights.

The shadow mask may be generated by applying auxiliary data to the neural network model together with the rendered scene, and the auxiliary data may include at least one of depth information, normal information, and motion vector information.

The rendering method may further include: cropping the shadow mask according to a mask region corresponding to each light, and transmitting the cropped shadow mask to a rendering engine.

The plurality of light types may include at least one of: a directional light corresponding to sunlight; and a non-directional light comprising at least one of a rectangular light, a spot light, and a point light corresponding to an indoor light.

The rendering method may further include grouping the spot light and the point light into a first light type from among the plurality of light types; and grouping the rectangular light into a second light type from among the plurality of light types.

The rendering method may further include: performing pre-processing on the input texture to obtain a pre-processed input texture, wherein the shadow mask may be generated by applying the pre-processed input texture to the neural network model.

The performing the pre-processing may include at least one of: performing a pixel-wise linear operation on the input texture; performing a pixel-wise non-linear operation on the input texture; performing a unary operation on an individual input texture for each light type; performing a binary operation between two input textures corresponding to the plurality of light types; and performing blurring on the input texture.

The shadow mask may be generated by performing post-processing on an output of the neural network model by performing at least one of a residual path connection and kernel filtering on the output of the neural network model.

In accordance with an aspect of the disclosure, a non-transitory computer-readable medium is configured to store instructions which, which executed by at least one processor, cause the at least one processor to: based on information about a plurality of lights included in a rendered scene corresponding to a view associated with a camera, classify the plurality of lights according to a plurality of light types; generate an input texture corresponding to each light type from among the plurality of light types; generate a shadow mask configured to reduce shadow noise in a shadow corresponding to each light type by applying the input texture to a neural network model; and reduce the shadow noise in the rendered scene using the shadow mask.

In accordance with an aspect of the disclosure, an electronic device, includes: a memory configured to store a neural network model; and at least one processor configured to: based on information about a plurality of lights included in a rendered scene corresponding to a view associated with a camera, classify the plurality of lights according to a plurality of light types; based on luminances of lights classified as a same light type from among the plurality of lights, generate an input texture corresponding to each light type from among the plurality of light types; generate a shadow mask configured to reduce shadow noise in a shadow corresponding to each light type by applying the input texture to the neural network model; and reduce the shadow noise in the rendered scene using the shadow mask.

In accordance with an aspect of the disclosure, a rendering method includes: determining a camera view associated with a rendered scene; determining a plurality of lights that are visible in the rendered scene according to the camera view; classifying the plurality of lights into a plurality of light types; generating a plurality of input textures corresponding to the plurality of light types based on information about the plurality of lights; generating a plurality of shadow masks corresponding to the plurality of light types by providing the plurality of input textures as input to a neural network model; and reducing shadow noise included in the rendered scene based on the plurality of shadow masks.

The plurality of lights may include a first light corresponding to a first light type, a second light corresponding to a second light type, and a third light corresponding to the second light type.

The plurality of input textures may include a first input texture corresponding to the first light type, and a second input texture corresponding to the second light type. The first input texture may be generated based on the first light, and the second input texture may be generated based on the second light and the third light.

The plurality of shadow masks may include a first shadow mask corresponding to the first light type, and a second shadow mask corresponding to the second light type. The first shadow mask may be generated based on the first input texture, and the second shadow mask may be generated based on the second input texture.

### BRIEF DESCRIPTION OF THE DRAWINGS

The above and/or other aspects will be more apparent from descriptions of certain embodiments referring to the accompanying drawings, in which:

FIG. 1 is a diagram illustrating a process for processing noise that occurs at a boundary of a shadow caused by light scattering in hybrid rendering, according to an embodiment;

FIG. 2 is a flowchart illustrating a rendering process, according to an embodiment;

FIGS. 3A and 3B are diagrams a process for reducing or eliminating shadow noise in a shadow caused by lights in a single pass, according to embodiments;

FIG. 4 is a diagram illustrating a process for eliminating shadow noise in a shadow caused by lights in a single pass, according to an embodiment;

FIGS. 5A to 5C are diagrams illustrating detailed operations of each component of an electronic device, according to an embodiment;

FIG. 6 is a diagram illustrating a process for reducing or eliminating shadow noise in a shadow caused by lights in a single pass, according to an embodiment;

FIG. 7 is a diagram illustrating a process for reducing or eliminating shadow noise in a shadow caused by lights in a single pass, according to an embodiment;

FIG. 8 is a diagram illustrating a case in which light types are input to a neural network model with the order of the light types rearranged, according to an embodiment;

FIG. 9 is a diagram illustrating a case in which pre-processing and post-processing are performed in an electronic device, according to an embodiment; and

FIG. 10 is a block diagram illustrating an electronic device according to an embodiment.

### DETAILED DESCRIPTION

The following detailed structural or functional description is provided as an example only and various alterations and modifications may be made to embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, or the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein may have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

The example embodiments described below may be used for, for example, a content providing device for providing video content, a video broadcasting device, a terminal device for performing video transmission in a video call or a video conference, or a mobile application processor (AP).

Hereinafter, embodiments are described in detail with reference to the accompanying drawings. When describing the embodiments with reference to the accompanying drawings, like reference numerals refer to like elements and a repeated description related thereto will be omitted.

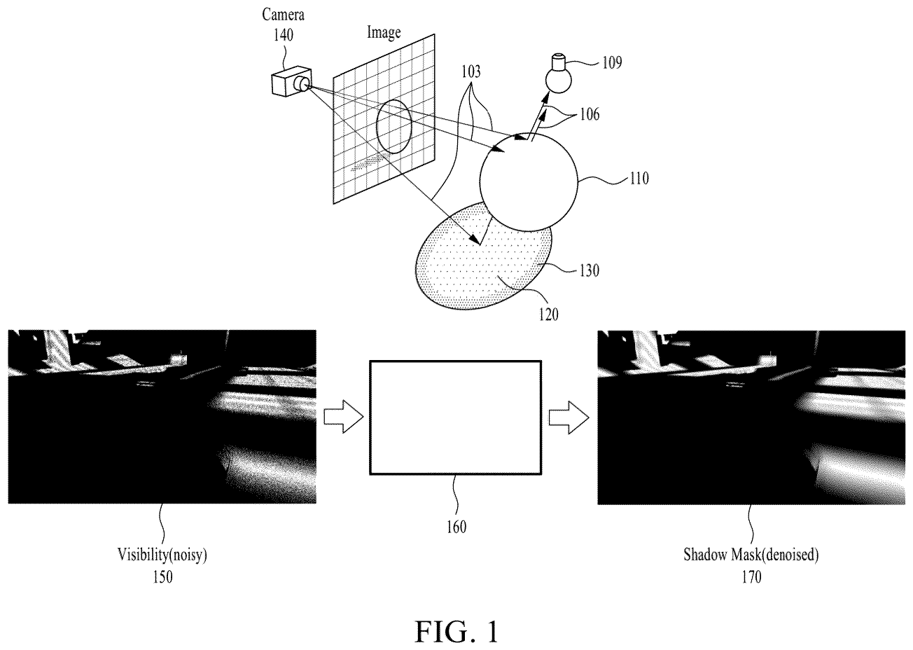

FIG. 1 is a diagram illustrating a process for processing noise that occurs at a boundary of a shadow caused by light scattering in hybrid rendering.

A hybrid rendering technique may use ray tracing to render shadow generation for realistic shadowing while being based on a rasterization rendering technique.

Ray tracing may refer to a technique based on Monte Carlo sampling. When a view ray 103 is irradiated by a camera 140, the details of how light is reflected, refracted, and propagates on a surface of a scene object 110 may be approximated and casted using a probability-based sampling technique, thereby rendering a high-quality image. However, since it may be difficult or impossible to trace and calculate numerous view rays for every pixel of a rendered image, ray tracing may be used for precise expression while processing basic rendering quickly using a rasterization technique to maintain real-time performance with limited hardware resources.

Because the camera 140 may move continuously during actual rendering, light information (e.g., the number of lights, light types, etc.) may vary depending on the view that is actually being viewed by the camera 140.

Shadow generation used in hybrid rendering may be useful for handling a penumbra region 130 generated by light scattering at the edge of a shadow 120 corresponding to the scene object 110. The penumbra region 130 may also be referred to as a partial shadow region. A shadow ray 106 may reach the penumbra region 130 irregularly according to a probability-based sampling technique. Because it may be practically difficult to cast numerous view rays (e.g., view ray 103) in real time to smoothly express the shadow ray 106, which may arrive irregularly, a denoising technique that eliminates irregular noise may be used.

In a rendering engine, visibility texture information 150 including noise due to ray tracing may be converted into a smooth shadow mask 170 with continuous values with noise that is reduced or eliminated through a denoising algorithm 160. Here, the visibility texture information may be expressed as hit (e.g., a value of zero (“0”)) or a miss (e.g., a value of one (“1”)). A hit may indicate a state in which a light 109 is obscured by the scene object 110 and may be expressed as, for example, one or more black pixels. A miss may indicate a state in which the light 109 is not obscured by the scene object 110 and may be expressed as, for example, one or more white pixels.

The denoising algorithm 160 may reduce or eliminate noise and express a soft shadow in the penumbra region 130 by performing multiple stages of blurring on the light 109. In this case, to improve resource efficiency, lights may be grouped into groups (e.g., groups of four) and processed as batch units. Because lights may have different light types, each light in a batch may be processed one by one according to each light type. This process may be referred to as a single-light multi-pass process.

However, in a situation in which real-time performance is important and there are multiple lights that may be processed dynamically, the processing cost for shadowing through ray tracing may increase linearly, so processing all lights individually may not guarantee real-time performance.

Additionally, when multiple lights are grouped and processed all in one time in a single pass, light types may be processed in different processes based on a light type. Additionally, shadow regions affected by respective lights may overlap each other. In such a case, it is difficult to handle overlapping shadow regions without additionally using a shadow map used in rasterization.

According to embodiments, for the same light type, a weighted sum may be used to generate a combined input texture, and a texture corresponding to a light type may be input according to the number of channels of a neural network model so that multiple lights may be processed at once using a single pass, even when shadows overlap each other regardless of the light type, while ensuring real-time performance.

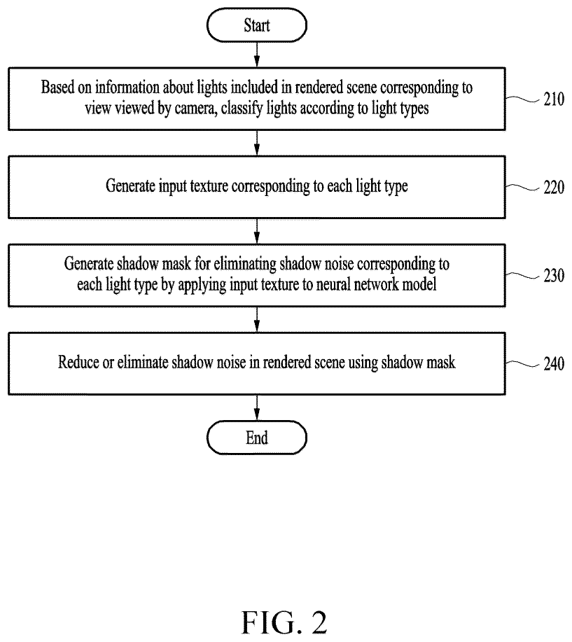

FIG. 2 is a flowchart illustrating a rendering process according to an embodiment. Operations described hereinafter with reference to FIG. 2 may be performed sequentially but embodiments are not limited thereto. For example, the order of the operations may change, and at least two of the operations may be performed in parallel.

Referring to FIG. 2, an electronic device according to an embodiment may reduce or eliminate shadow noise in a shadow from a rendered scene through operations 210 to 240.

At operation 210, the electronic device may classify, based on information about a plurality of lights included in the rendered scene corresponding to a view that is viewed by a camera, the plurality of lights according to a plurality of light types. A rendered scene may be a view or an image frame corresponding to a current timepoint, and may be provided as input data for an electronic device. The information about lights included in the rendered scene may include both information about lights that are visible in the rendered scene and/or information about lights that exist but are not visible in the current view because they are obscured by other objects. The rendered scene may include at least one of a visibility texture of lights, a blur radius texture indicating the size of a penumbra corresponding to a blur level caused by shadows generated by the lights, history information, in which information about shadow rays is accumulated, including temporal information corresponding to previous frames of the rendered scene, and light distance information corresponding to the lights. Here, the visibility texture of a light may indicate how visible the light is in a current image (or view), (e.g., how visually distinct the light is within the scene). The visibility texture of a light may be determined by the light's position, intensity, color, and/or interaction with a shadow. The history information may correspond to information obtained by accumulating information about visibility textures. The light distance information may refer to the distance to a primary hit point, which may be the point at which a light first reaches the surface of an object when the light is shot from a camera.

According to embodiments, each light may be associated with a visibility texture, a blur radius texture, history information, and/or light distance information included in a rendered scene may exist.

The plurality of light types may include at least one of a directional light type corresponding to sunlight, at least one non-directional light type including a rectangular light type, a spot light type, and a point light type corresponding to an indoor light. According to embodiments, a light corresponding to a directional light type may be referred to as a directional light. Similarly, a light corresponding to a non-directional light type may be referred to as a non-directional light, a light corresponding to a rectangular light type may be referred to as a rectangular light, a light corresponding to a spot light type may be referred to as a spot light, and a light corresponding to a point light type may be referred to as a point light. According to embodiments, light types may be grouped together, and a light may correspond to more than one light type. As an example, a light corresponding to a spot light type may also correspond to a non-directional light type, and therefore a spot light may also be referred to as a non-directional light. In addition, multiple light types may be grouped into any other light types (e.g., a first light type, a second light type, etc.).

A rectangular light may have a rectangular shape. A spot light may be focused on a predetermined point. A spot light may be used on stages or at exhibitions, and may produce a strong view ray to highlight a predetermined person or object. A spot light may be produced by a lamp, a reflector, and lens, and may control the range and shape of light. A point light may radiate in all directions from a single position. A point light may spread light in all directions, similar to incandescent light bulbs, and may radiate from a predetermined point that is centered in the light. A point light may be used in a variety of spaces due to the aforementioned characteristics and may be particularly effective in highlighting a small space or a predetermined object.

A directional light may affect the entire region of a scene. A non-directional light may have a predetermined region of influence on each scene. Light types and the number of lights in a scene may be predetermined. According to embodiments, the number of light types may correspond to the number of input and output channels of a neural network model that may be used during a rendering of the scene.

The electronic device may classify directional lights and non-directional lights as lights having different light types. In other words, a directional light and a non-directional light may be classified as having different light types.

At operation 220, the electronic device may generate an input texture corresponding to each of the light types classified in operation 210. The electronic device may generate a single input texture for each light type. For example, when the number of light types is three, the electronic device may generate three input textures, and when the number of light types is one, the electronic device may generate one input texture. When there is only one light for each light type, the electronic device may use, as an input texture, a texture in the form of raw data corresponding to one light. Additionally, when there are multiple lights per light type, the electronic device may generate one input texture using a weighted sum based on luminances corresponding to the multiple lights of the same type.

For example, the electronic device may generate one input texture corresponding to lights classified as corresponding to the same type, based on the luminance of the lights classified as corresponding to the same type.

The electronic device may calculate the luminance of the lights classified as corresponding to the same type. In this case, because it may not be known which light affects a pixel, the electronic device may calculate the luminance of the lights by applying a luminance 510 corresponding to each light to a weighted sum 410 of visibility textures and blur radius textures, and averaging the weighted sum 410 by dividing the weighted sum 410 by the number of lights.

In some embodiments, the electronic device may calculate the luminance of the lights by considering a light distance corresponding to each of the lights classified as the same type. The electronic device may calculate the luminance of the lights by assigning different weights to the lights based on a light distance. The electronic device may generate one input texture corresponding to the lights classified as corresponding to the same type using the weighted sum based on the calculated luminance. The electronic device may generate an input texture using the weighted sum based on a light distance, regardless of the number of overlapping lights per pixel in a rendered scene. The electronic device may generate an input texture using the weighted sum to which different weights are assigned according to a light distance of each of the lights classified as the same type.

The electronic device may use the luminance of each light to combine the visibility textures and the blur radius textures included in the rendered scene into one texture input through the weighted sum. Regardless of the overlap of a shadow region of each light, the electronic device may transmit input information for shadow denoising to the neural network model through a weighted sum based on a light distance corresponding to the same light type.

According to an embodiment, the electronic device may group, among the light types classified in operation 210, a spot light and a point light belonging to a non-directional light into a first light type and may group a rectangular light into a second light type. In this case, at operation 220, the electronic device may generate an input texture corresponding to a non-directional light using a weighted sum of the luminance of each light corresponding to the first type and a light corresponding to the second type.

At operation 230, the electronic device may generate a shadow mask for reducing or eliminating shadow noise in a shadow corresponding to each light type by applying the input texture generated in operation 220 to the neural network model. The number of input channels of the neural network model may be proportional to the preset number of light types. The neural network model may be trained to generate a shadow mask corresponding to each light type, regardless of the number of light types, the number of lights, or the order of the lights, all of which may vary depending on a view viewed by the camera in the rendered scene. The neural network model may generally refer to a model having a problem-solving ability implemented through artificial neurons (or nodes) forming a network through synaptic connections where the strength of the synaptic connections is changed through training or machine learning. An artificial neuron of the neural network model may include a combination of weights and/or biases. The neural network model may include one or more layers including a plurality of artificial neurons.

The electronic device may determine whether a light type from among a predetermined plurality of light types exists is missing from the light types classified in operation 210. According to the determination that the missing light type is missing from the, the electronic device may generate a dummy output corresponding to a shadow mask and a black dummy texture corresponding to each of the light types by applying the black dummy texture corresponding to the missing light type to the neural network model together with the input texture. In this case, the black dummy texture corresponding to the missing light type may be generated by the electronic device, or may be used by calling a pre-generated black dummy texture.

Additionally, the electronic device may generate a shadow mask for reducing or eliminating shadow noise in a shadow corresponding to each light type by applying auxiliary data together with the rendered scene to the neural network model. The auxiliary data may include at least one type of information (e.g., a G-buffer texture) from among depth information, normal information, and motion vector information generated corresponding to each pixel of the rendered scene in a rendering engine.

At operation 240, the electronic device may reduce or eliminate shadow noise in a shadow included in the rendered scene using the shadow mask generated at operation 230. The electronic device may reduce or eliminate shadow noise in a shadow included in the rendered scene by cropping a shadow mask according to a mask region (e.g., a rectangular mask region) corresponding to each light and transmitting the cropped result to the rendering engine. Information about the mask region may be provided in advance by the rendering engine.

The electronic device may be implemented within a portable device such as a personal computer (PC), a cloud server, a data server, or a mobile device. The portable device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, and/or a smart device. The smart device may be implemented as a smart watch, a smart band, smart glasses and/or a smart ring.

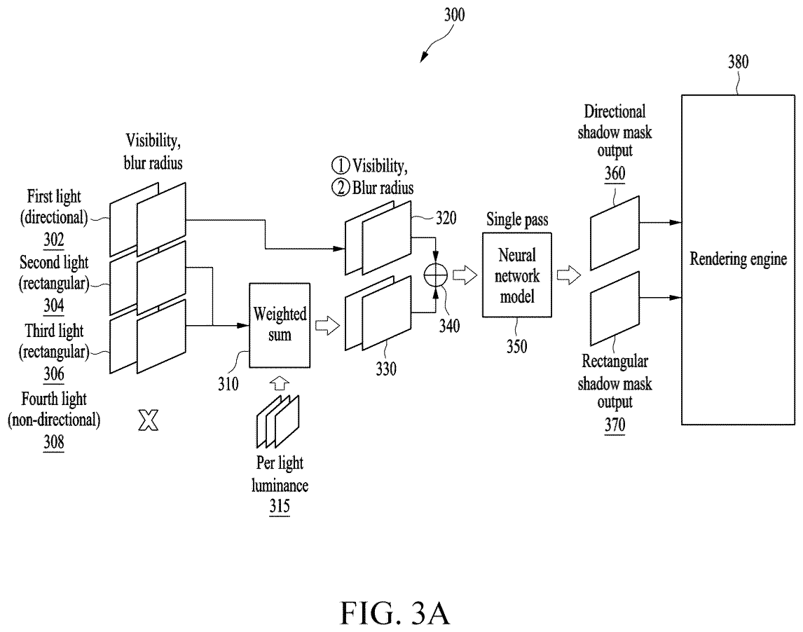

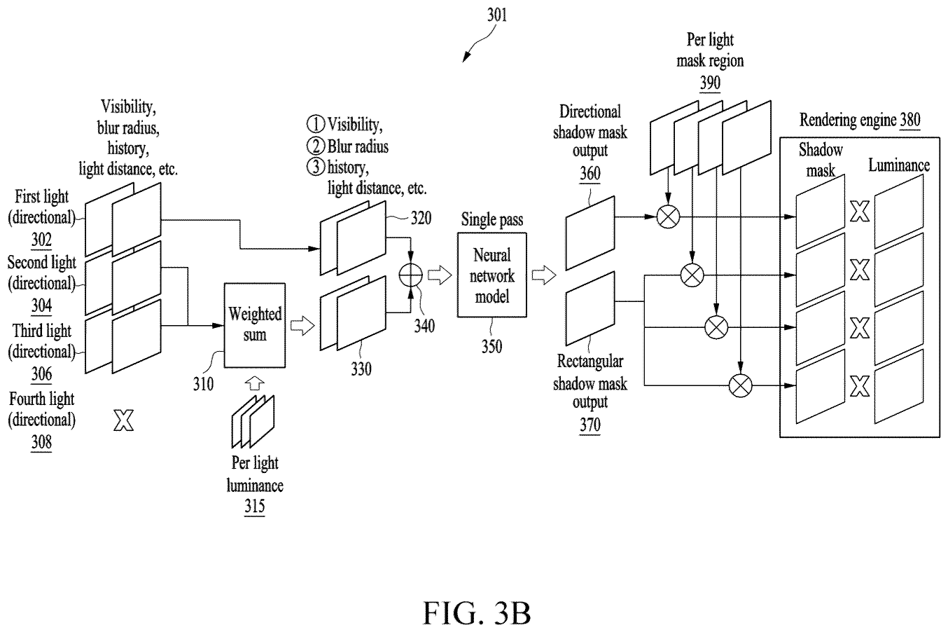

FIGS. 3A and 3B are diagrams of a process for eliminating noise of a shadow caused by lights in a single pass, according to embodiments. As shown in FIGS. 3A and 3B, a diagram 300 and a diagram 301 may be used to describing an operation of a case in which a rendered scene (e.g., a current view) having two light types (e.g., a directional light and a rectangular light) and three lights (e.g., a first light 302, a second light 304, and a third light 306) is input to a neural network model 350 that is trained to operate based on two light types and four lights.

Generally, within a scene, there may be a directional light corresponding to sunlight and a non-directional light, such as a rectangular light, a spot light, and a point light, that acts as an indoor light.

In FIG. 3A, because there may be usually one first light 302 corresponding to a directional light, the electronic device may directly transmit, to the neural network model 350, a visibility texture and a blur radius texture 320 corresponding to the first light 302. The neural network model 350 may be trained to generate a shadow mask corresponding to each light type, regardless of the number of light types, the number of lights, or the order of lights that vary depending on a view viewed by a camera in the rendered scene. The neural network model 350 may be, for example, a neural shadow denoising (NSD) network that is configured to receive a visibility texture and a blur radius texture as an input, but embodiments are not limited thereto.

In addition, in a scene, there may be multiple non-directional rectangular lights such as the second light 304 and the third light 306. The electronic device may generate one input texture 330 corresponding to the rectangular light type through a weighted sum 310 of the visibility texture and the blur radius texture corresponding to each of the rectangular lights (e.g., corresponding to the second light 304 and the third light 306).

The electronic device may obtain a combination 340 of a visibility texture and a blur radius texture 320 corresponding to the first light 302 with one input texture 330 corresponding to the rectangular light, and apply the combined result to the neural network model 350. Here, the combination 340 may be obtained using, for example, concatenation.

The neural network model 350 may generate a shadow mask 360 corresponding to the directional light type (e.g., corresponding to the first light 302) and a shadow mask 370 corresponding to the rectangular light type (e.g., corresponding to the second light 304 and the third light 306) and transmit the shadow mask 360 and the shadow mask 370 to a rendering engine 380. The rendering engine 380 may perform shadowing expressing a shadow caused by a light in a rendered image using the shadow mask 360 and the shadow mask 370.

For ease of description, a case in which a visibility texture and a blur radius texture corresponding to each light are applied to the neural network model is described as an example with reference to FIGS. 3A and 3B. However, a different additional texture for each light may be applied to the neural network model 350.

The neural network model 350 may be set to use a visibility texture and a blur radius texture for each light type as an input. Therefore, one visibility texture and one blur radius texture corresponding to the directional light may be used. Similarly, one visibility texture and one blur radius texture corresponding to the rectangular light may be used.

Types of rectangular lights may include multiple rectangular lights. In the example shown in FIGS. 3A and 3B, the number of directional lights may be set to one and the number of rectangular lights may be set to three. However, because only two rectangular lights may exist in the current view (e.g., because a fourth light 308 may not be visible in the current view), the electronic device may transmit the weighted sum 310 of the visibility textures and the blur radius textures corresponding to two rectangular lights (e.g., the second light 304 and the third light 306) to the neural network model 350.

The electronic device may generate one input texture 330 corresponding to the rectangular light type using the weighted sum 310 based on per light luminance 315. The per light luminance 315 may correspond to the rectangular light type (e.g., the second light 304 and the third light 306). The electronic device may calculate the luminance of lights classified as corresponding to the rectangular light type. The electronic device may calculate the luminance of lights classified as corresponding to the same type by applying the luminance 315 corresponding to each light and averaging the weighted sum of the visibility textures and the blur radius textures, according to the number of overlapping lights per pixel of the rendered scene.

However, unlike the examples of FIGS. 3A and 3B, when there is no rectangular light type in a predetermined camera view, the electronic device may transmit a black dummy texture to the neural network model 350 instead of an input texture corresponding to the rectangular light type. In this case, the neural network model 350 may perform denoising only on texture information corresponding to the directional light (e.g., the first light 302).

The electronic device may transmit an output according to the light type to the rendering engine 380 after performing denoising by the neural network model 350. In this case, as illustrated in FIG. 3B, the electronic device may crop the shadow mask 360 and the shadow mask 370 according to a mask region 390 corresponding to each of the lights and transmit the results to the rendering engine 380. The shadow mask 370 may be cropped into three parts according to each mask region corresponding to three preset rectangular lights and transmitted to the rendering engine 380. Each mask region may be, for example, a rectangular mask that divides a region affected by each light into a value of zero (“0”) or a value of one (“1”). Information about a mask region may be provided in advance by the rendering engine 380.

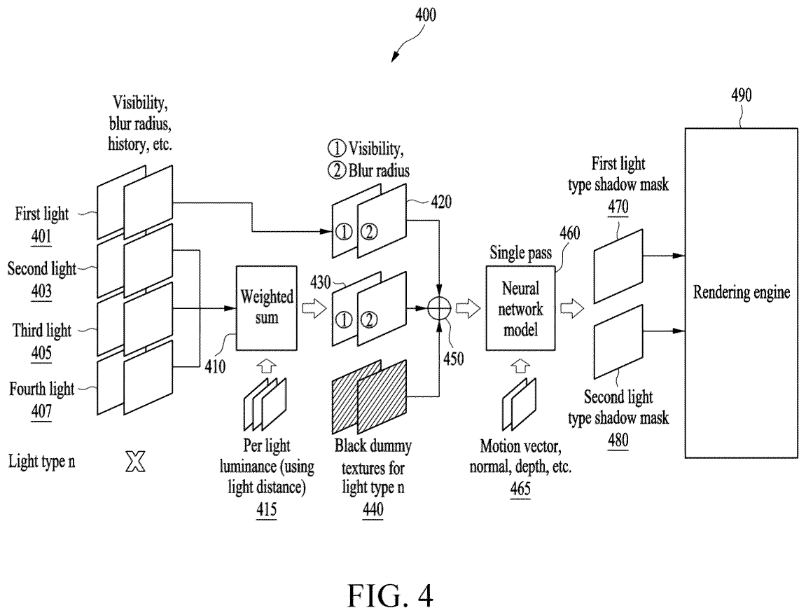

In FIGS. 3A and 3B, a fourth light 308 may be set as a rectangular light, but because there may be no information about the rectangular light in the current view, the fourth light may not be included in the calculation of the weighted sum 310. Therefore, the mask region corresponding to the fourth light may not need to be cropped and may not be processed in the shadowing process of the rendering engine 380. An operation in which there is no light corresponding to a light type preset in the current view is described in more detail below with reference to FIG. 4.

FIG. 4 is a diagram illustrating a process for eliminating noise of a shadow caused by lights in a single pass, according to an embodiment. FIG. 4 illustrates a diagram 400 of a multi-light single-pass technique for denoising multiple lights in a single pass.

The electronic device may reduce or eliminate shadow noise in a shadow without an additional texture or a separate analysis algorithm by generating an input texture through a weighted sum based on the luminance of each light, even when shadows respectively corresponding to lights overlap each other, regardless of the light type.

The electronic device may calculate a weighted sum based on luminance for the same light type to generate one input texture corresponding to the light type and input the input texture to a neural network model 460. The electronic device may generate input textures corresponding to separate input channels for different light types and input the input textures to the neural network model 460. Additionally, the electronic device may generate a black dummy texture for a light type that is not visible in the current view and input the black dummy texture to the neural network model 460. Accordingly, the electronic device may ensure real-time performance by processing multiple lights in one time in a single pass.

In an embodiment, a view scene, in which there is no light corresponding to the n-th light type, may be input to an electronic device in which the number of light types is set to n. In this case, a visibility texture and a blur radius texture corresponding to each of the lights (e.g., each of a first light 401, a second light 403, a third light 405, and a fourth light 407) visible in a rendered scene representing the current view may be provided as an input for performing denoising on each light type.

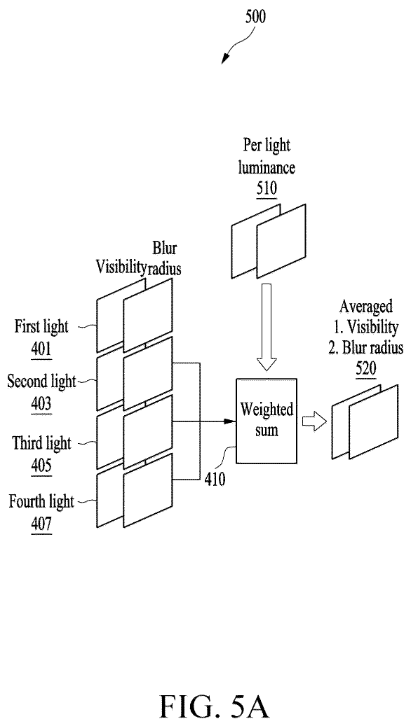

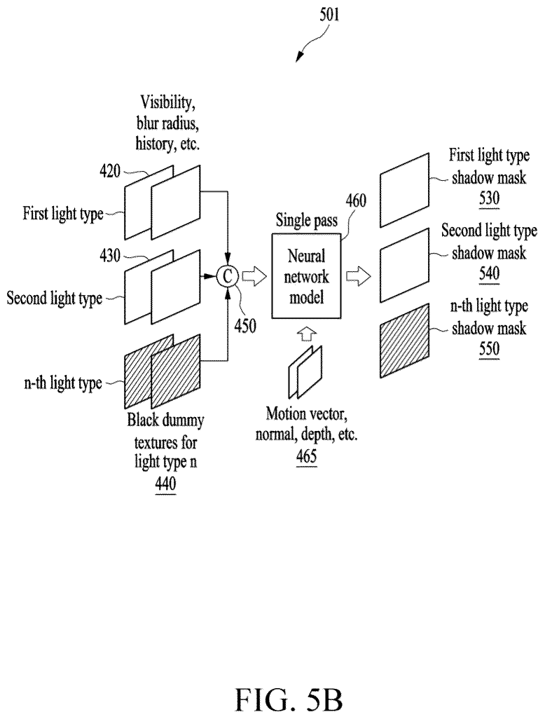

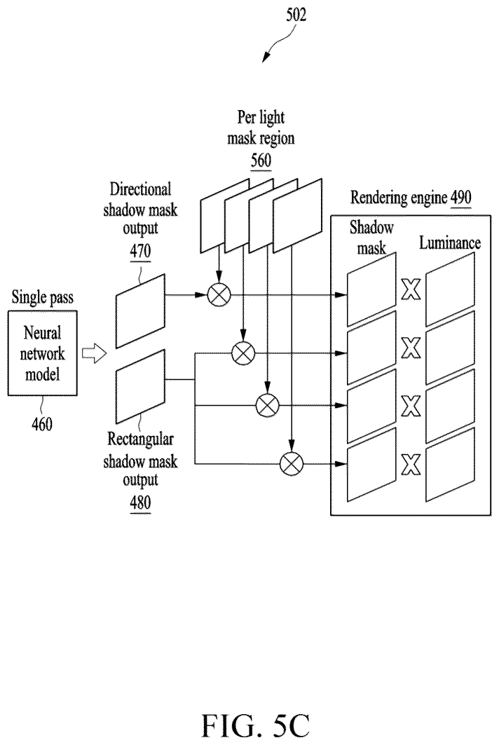

The electronic device may classify all lights (e.g., the first light 401, the second light 403, the third light 405, and the fourth light 407) visible in the rendered scene according to light types. For example, the first light 401 may correspond to a first light type, the second light 403 may correspond to a second light type, the third light 405 may correspond to a third light type, and the fourth light 407 may correspond to a fourth light type. The electronic device may calculate the brightness (e.g., the per light luminance 415) of each of the lights belonging to the same type. The electronic device may combine visibility textures and blur radius textures into one input texture by calculating a weighted sum 410 of the visibility textures and the blur radius textures, based on the per light luminance 415 belonging to the same type. In this case, the electronic device may adjust a weight corresponding to each of the visibility textures and blur radius textures according to the per light luminance 415. For example, when a light type is not a directional light, the luminance of a light may be attenuated depending on a light distance from an object. The electronic device may calculate luminance by considering luminance attenuation according to a light distance and calculate the weighted sum 410 based on per light luminance. The electronic device may, for example, apply greater attenuation of luminance as the light distance increases and less attenuation as the light distance decreases. An example of a process by which the electronic device may calculate the weighted sum 410 is described in more detail below with reference to FIG. 5A.

For example, when there is only one light for each light type, such as the first light 401 corresponding to a first light type, the electronic device may transmit a visibility texture and a blur radius texture corresponding to the first light 401 as input texture information 420 in the form of raw data to the neural network model 460.

As a camera view is moved, there may be a light type that is not visible in a rendered scene corresponding to the camera view but is visible in another camera view. As the camera view changes, the electronic device may process denoising on a shadow even for a light type that is not visible in a current view. Here, the light type not visible in the current view may correspond to a light type that is missing among predetermined light types input to the neural network model 460.

In the neural network model 460, a rendered scene may be applied according to a predetermined input form. This is because the number of input channels of the neural network model 460 may be proportional to the preset number of light types. Therefore, when there is a light type not visible in a corresponding camera view, the electronic device may generate and apply a black dummy texture (e.g., black dummy input texture information 440) together with a visibility texture and a blur radius texture corresponding to another light type. Here, a light type not visible in a corresponding camera view may mean that a light type that is missing among the preset light types input to the neural network model 460 in light types classified by the electronic device.

In this case, in addition to the visibility texture and blur radius texture corresponding to each light, various pieces of information such as temporal information and/or light distance information may be used as input data for the neural network model 460. Temporal information may correspond to history information in which information about shadow rays or visibility textures corresponding to previous frames of the rendered scene are accumulated. Temporal information and/or light distance information may be input in proportion to the number of lights. An operation of the neural network model 460 is described in detail below with reference to FIG. 5B.

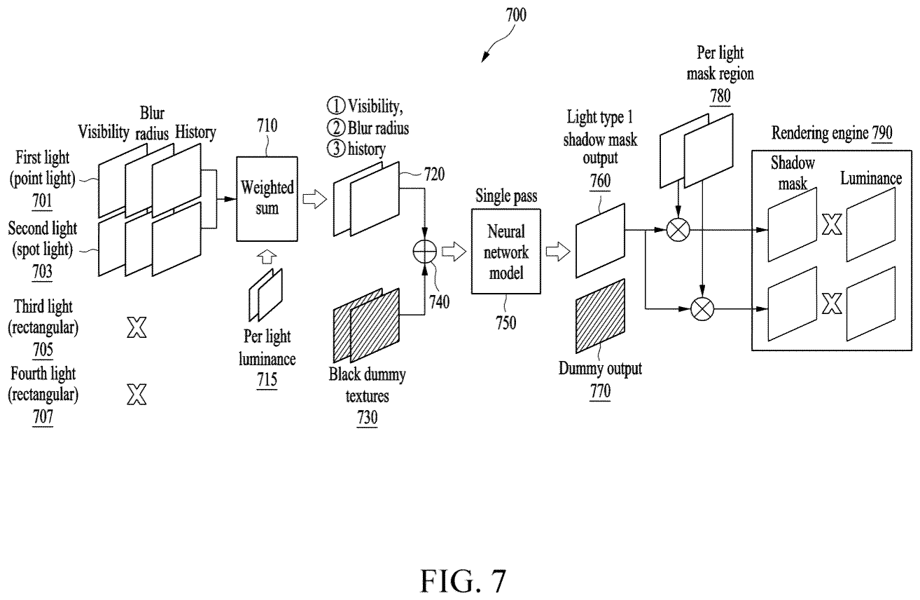

Because light types are limited to a certain number of types, such as a directional light, a rectangular light, a spot light, and/or a point light, an increase in the number of lights may not proportionally increase the number of light types. Additionally, non-directional lights (e.g., a rectangular light, a spot light, and a point light) that have completely different properties from directional lights may be grouped into the same light type to calculate the weighted sum 410. An embodiment of grouping non-directional lights into the same light type is described in detail below with reference to FIG. 7.

Additionally, auxiliary data 465 generated by the rendering engine 490 may also be input to the neural network model 460 together with input texture information corresponding to each light type (e.g., input texture information 420 corresponding to the first light 401, input texture information 430 corresponding to the second light 403 and third light 405, and black dummy input texture information 440 corresponding to the missing light type). The auxiliary data 465 may include G-buffer information, such as distance information, normal information, and motion vector information corresponding to each pixel of a current rendered scene. In this case, the auxiliary data 465 may be used regardless of the number of lights.

The neural network model 460 may be trained to output only output data corresponding to a light type that has an actual input value (e.g., an input texture), even when the neural network model 460 receives the black dummy texture 440 as an input. The neural network model 460 may output an output corresponding to each light type regardless of the presence or absence of the black dummy texture 440. For example, the neural network model 460 may output shadow masks 470 and 480 with noise reduced or eliminated (e.g., denoised shadow masks) corresponding to each light type by being trained by a data set corresponding to both the case in which the black dummy input texture information 440 is used, and the case in which the black dummy input texture information 440 is not used.

According to an embodiment, real-time performance may be ensured by performing denoising on a plurality of lights in one time in a single pass.

The shadow masks 470 and 480 respectively corresponding to light types may be distributed to the rendering engine 490 according to a rectangular mask occupied by a view frustum of a light and transmitted as input for shadowing so that each light may use the shadow masks. The view frustum may correspond to the shape of a region viewed and rendered by a perspective camera. In other words, the rendering engine 490 may perform rendering assuming that an object is visible on a screen when the object is within a view frustum region in the shape of a rectangular pyramid.

An example of a process by which the electronic device may distribute and transmit the shadow masks 470 and 480 according to a rectangular mask is described in detail below with reference to FIG. 5C.

FIGS. 5A to 5C are diagrams illustrating detailed operations of each component of an electronic device, according to an embodiment.

FIG. 5A illustrates a diagram 500 for describing a process in which an electronic device according to an embodiment calculates the weighted sum 410.

The electronic device may calculate the weighted sum 410 based on per light luminance to generate a combined input texture corresponding to a plurality of lights belonging to the same type.

The electronic device may classify all lights (e.g., the first light 401, the second light 403, the third light 405, and the fourth light 407) visible in the rendered scene according to light types. The electronic device may calculate the brightness (e.g., the luminance 415) of each light having the same type. The electronic device may combine visibility textures and blur radius textures into one input texture by calculating the weighted sum 410 of the visibility textures and the blur radius textures, based on the per light luminance 415 of the lights belonging to the same type.

The electronic device may apply a corresponding luminance 510 to each light according to the number (e.g., 3 of {1,2,3}) of lights overlapping for each pixel in the rendered scene and average 520 the weighted sum 410 of the visibility textures and the blur radius textures.

For example, when each of the second light 403, the third light 405, and the fourth light 407 are directional lights, the electronic device may calculate luminance by considering a light distance corresponding to the second light 403, a light distance corresponding to the third light 405, and a light distance corresponding to the fourth light 407 (e.g., a light distance corresponding to each of the lights classified as the same type). The electronic device may calculate the luminance 415 using the light distance from each of the second, third, and fourth lights 403, 405, and 407 to the point at which a ray corresponding to each light first collides with an object surface.

In this case, the electronic device may adjust a weight corresponding to a visibility texture according to the per light luminance 415. For example, when the type of a light is not a directional light, the luminance of the light may be attenuated depending on the light distance between an object and the light. The electronic device may calculate the luminance by considering luminance attenuation according to a light distance and calculate the weighted sum 410 based on the per light luminance. The electronic device may, for example, apply greater attenuation of luminance as the light distance increases and less attenuation as the light distance decreases.

Additionally, the electronic device may also calculate a weighted sum of a noise-reduced or noise-eliminated shadow mask (e.g., a soft shadow mask(S)) for training a neural network model.

The electronic device may calculate a weighted sum of a visibility texture (V), a blur radius texture (P), and a shadow mask(S) according to per light luminance (L), for example, by Equation 1 below.

$${\sum }_{l ∈ \{ 1 , 2 , 3 \}} ( {L}_{l} * {V}_{l} ) = [ {\sum }_{l} {L}_{l} ] * [ {\sum }_{l} ( {L}_{l} * {V}_{l} ) / {\sum }_{l} {L}_{l} ] = [ {\sum }_{l} {L}_{l} ] * [ \overline{V} ] \qquad [ Equation 1 ]$$

$${\sum }_{l ∈ \{ 1 , 2 , 3 \}} ( {L}_{l} * {P}_{l} ) = [ {\sum }_{l} {L}_{l} ] * [ {\sum }_{l} ( {L}_{l} * {P}_{l} ) / {\sum }_{l} {L}_{l} ] = [ {\sum }_{l} {L}_{l} ] * [ \overline{P} ]$$

$${\sum }_{l ∈ \{ 1 , 2 , 3 \}} ( {L}_{l} * {S}_{l} ) = [ {\sum }_{l} {L}_{l} ] * [ {\sum }_{l} ( {L}_{l} * {S}_{l} ) / {\sum }_{l} {L}_{l} ] = [ {\sum }_{l} {L}_{l} ] * [ \overline{S} ]$$

Here, V̅ may denote the average value of visibility textures. P̅ may denote the average value of blur radius textures. S̅ may denote the average value of shadow masks. V̅, P̅, and S̅ may be multiplied for each light when transmitted to the rendering engine.

In order to process a shadowing process for each light in a single-light multi-pass process as a single pass for multiple lights, a weighted sum may have to be calculated for a light affecting each pixel. For an input used in a neural network model and an output (e.g., a shadow mask) for training, one input and one output for multiple lights may be obtained through a weighted sum by the per light luminance 510. Equation 1 may be used to reconstruct the equation for the shadowing process of a single-light multi-pass corresponding to the left-hand side into a calculation formula for the weighted sum of an input and an output on the right-hand side so that the calculation formula may be processed in a single-light multi-pass.

In addition, the electronic device may also generate ground truth (GT) by increasing the number of sampled rays per pixel, which may also be referred to as samples per pixel (SPP). As an SPP value increases, more rays may be calculated for each pixel, which may mean higher image quality and less noise. For example, when an SPP value is one (“1”), only one ray may be sampled for each pixel, but when the SPP value is one hundred (“100”), one hundred rays may be sampled for each pixel. Accordingly, a higher SPP value may use more computations, which may result in longer rendering times, but the result may be a sharper, smoother image.

FIG. 5B illustrates a diagram 501 for describing training and inference of a neural network model, according to an embodiment.

The neural network model 460 may be pre-trained as, for example, a shadow denoising network. The number of input channels and/or the number of output channels (e.g., six) of the neural network model 460 may be set to match the number of light types (e.g., n). The number of input channels and/or the number of output channels of the neural network model 460 may be set by a user or may be automatically set according to an algorithm. The neural network model 460 may improve the image quality of a denoised shadow mask by learning through a data set.

The electronic device may apply, to the neural network model 460, output data (e.g., a shadow mask 530, a shadow mask 540, and a shadow mask 550) and the result obtained by obtaining a combination 450 of input data (e.g., input texture information 420, input texture information 430, and input texture information 440) for weighted rendered scenes corresponding to each light type for training. The electronic device may obtain a combination 450 the input data from the weighted rendered scenes by stacking the input data weighted rendered scenes in a channel direction. When training and inferring the neural network model 460, when there is a light type (e.g., n light type) that does not exist in a current camera view, the electronic device may apply the black dummy texture 440 corresponding to the n-th light type to the neural network model 460. In this case, the neural network model 460 may output a dummy output (e.g., the shadow mask 550) because the output corresponding to the light type (e.g., the n-th light type) that does not exist in the current camera view may be not used. The neural network model 460 may be trained in a state in which the number of light types to be processed is predetermined.

The electronic device may use an input texture such as a visibility texture, a blur radius texture, and the like for noise removal for shadows, but in addition, the auxiliary data 465 related to a light or a G-buffer, as illustrated in FIG. 5B, may be used together as input information or input data for the neural network model 460. For example, auxiliary data may include at least one piece of G-buffer information among depth information, normal information, and motion vector information generated by the rendering engine in response to each pixel of the rendered scene.

The auxiliary data 465 may be used, for example, to fit history information to a current frame. The electronic device may utilize the auxiliary data 465 (e.g., motion vector information) pixel-wise in the current frame to utilize previous frame information.

The neural network model 460 may include a convolutional layer configured to process an input in the form of an image, such as, for example, a visibility texture, a blur radius texture, and a G-Buffer texture applied as an input. Additionally, the neural network model 460 may include all operation layers capable of processing textures in the form of other images. The neural network model 460 may include an activation layer for non-linearity of a network. The neural network model 460 may include a layer that performs an arithmetic operation (e.g., add, multiply, divide, and subtract) between images. Additionally, the neural network model 460 may include layers that may be configured to change the structure of a stacked image, such as stacking, concatenating, pixel shuffling, and the like. An output of the neural network model 460 may be transmitted directly to the rendering engine or may be transmitted to a kernel filtering circuit in the form of kernel prediction that estimates a kernel for filtering.

FIG. 5C illustrates a diagram for describing a process for processing data output through inference of the neural network model, according to an embodiment.

The electronic device may transmit the shadow mask 470 and the shadow mask 480 with noise reduced or eliminated to the rendering engine 490, and may exclude a dummy output corresponding to the black dummy texture 440 among data output through inference of the neural network model 460.

The neural network model 460 may infer the shadow mask 470 corresponding to a directional light and the shadow mask 480 corresponding to a rectangular light, as illustrated in FIG. 5C. In this case, the electronic device may crop the shadow mask 470 and the shadow mask 480 inferred from the neural network model 460 according to a mask region (e.g., a rectangular mask region) 560 corresponding to each light, and transmit the cropped result to the rendering engine 490. In this case, for each light, information about the mask region 560 corresponding to a region affected by a corresponding light may exist. The information about the mask region 560 may vary depending on a light and/or an image frame. The mask region 560 corresponding to each light may be obtained by utilizing information provided from the rendering engine 490.

The rendering engine 490 may perform shadow generation (e.g., shadowing) by dividing and using the cropped shadow mask according to the mask region 560 according to the luminance of each light as in Equation 2 below.

$${\sum }_{l} ( {L}_{l} * \hat{S} ) = {\sum }_{l} ( {L}_{l} [ {M}_{l} ] * \hat{S} [ {M}_{l} ] ) = {L}_{0} [ {M}_{0} ] * \hat{S} [ {M}_{0} ] + {L}_{1} [ {M}_{1} ] * \hat{S} [ {M}_{1} ] + {L}_{2} [ {M}_{2} ] * \hat{S} [ {M}_{2} ] + {L}_{3} [ {M}_{3} ] * \hat{S} [ {M}_{3} ] \qquad [ Equation 2 ]$$

Here, M may denote a mask region (e.g., a rectangular mask region) corresponding to each light, and L may denote the luminance of each light. In addition, S may denote a weighted sum of the shadow mask 480 inferred through the neural network model 460.

The electronic device may redistribute the weighted shadow mask(S) 480 to each light to transmit, to the rendering engine 490, the inferred shadow masks 470 and 480 with noise reduced or eliminated through the neural network model 460. In Equation 2, the left-hand side corresponding to the shadowing process may be expressed in the form of the right-hand side by reconstructing the left-hand side by considering a rectangular mask Mₗ of each light. The weighted shadow mask (Ŝ) 480 may be represented in a cropped form by the rectangular mask Mₗ indicating a region affected by each light. The electronic device may obtain the same result as performing shadowing for each light by distributing the shadow mask weighted by Equation 1 described above according to the region affected by a light and transmitting the shadow mask to the rendering engine 490. The information about the mask region 560 may vary depending on each light and/or each frame.

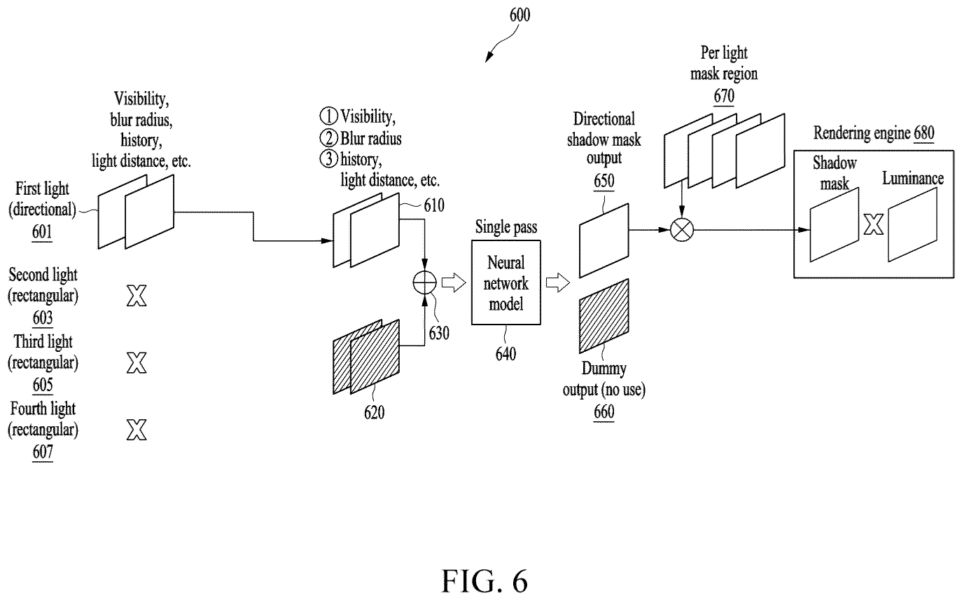

FIG. 6 is a diagram illustrating a process for eliminating noise of a shadow caused by lights in a single pass, according to an embodiment. FIG. 6 illustrates a diagram 600 for describing an operation in which a current view with one light and one light type is input to a neural network model 640 in which the number of light types is set to two and the number of lights is set to four.

For example, when there is one light type, such as a first light 601 corresponding to a directional light in a rendered scene, the electronic device may transmit raw data 610 as it is corresponding to the first light 601 to the neural network model 640. The raw data 610 may include visibility textures, blur radius textures, history information, and/or light distance information.

In this case, because there are not three lights corresponding to a preset light type (e.g., a rectangular light type) in the rendered scene (e.g. because the second light 603, the third light 605, and the fourth light 607 may not be visible in the rendered scene), the electronic device may generate a black dummy texture 620 corresponding to the rectangular light type. The electronic device may combine 630 the black dummy texture 620 with the raw data 610 and apply the combined result to the neural network model 640.

The neural network model 640 may be trained to generate output data (e.g., a directional shadow mask 650) corresponding to the first light 601, which is a light type with an actual input value (e.g., an input texture), even when the black dummy texture 620 is received as an input. In this case, the neural network model 640 may generate a dummy output 660 corresponding to the black dummy texture 620 in addition to the directional shadow mask 650 but may only output the directional shadow mask 650 without outputting the dummy output 660.

The neural network model 640 may be trained by a data set corresponding to both the case in which the black dummy texture 620 is used, and the case in which the black dummy texture 620 is not used. Therefore, the neural network model 640 may output the shadow mask 650 in which shadow noise is reduced or eliminated corresponding to each light type regardless of the presence or absence of the black dummy texture 620.

The electronic device may crop the directional shadow mask 650 inferred from the neural network model 640 according to a mask region 670 corresponding to the first light 601 and transmit the cropped result to a rendering engine 680. The rendering engine 680 may perform shadowing by dividing and using, according to the luminance of each light, the shadow mask cropped according to the mask region 670.

FIG. 7 is a diagram illustrating a process for eliminating noise of a shadow caused by lights in a single pass, according to an embodiment. FIG. 7 illustrates a diagram 700 for describing an operation when a rendering scene (e.g., a current view) with one light type and two lights is input to a neural network model 750 in which the number of light types is set to two and the number of lights is set to four, according to an embodiment.

An electronic device may group different light types to form a single pass and a single input texture 720. The electronic device may group a point light (e.g., the first light 701) and a spot light (e.g., the second light 703) among the light types into a first light type and group rectangular lights (e.g. the third light 705 and the fourth light 707) into a second light type. The electronic device may generate the input texture 720 corresponding to each of the first light type and the second light type using a weighted sum 710 based on luminance 715 of each of the first light type and the second light type.

The electronic device may group rectangular lights (e.g., the third light 705 and the fourth light 707) into one type. In this case, when the rectangular lights (e.g., the third light 705 and the fourth light 707) may be invisible in the current view, the electronic device may generate one black dummy texture 730 corresponding to the rectangular lights. The electronic device may obtain a concatenation 740 of the input texture 720 and the black dummy texture 730 and transmit the concatenated result to the neural network model 750.

The neural network model 750 may generate a shadow mask 760 corresponding to the first light type for the input texture 720 and generate a dummy output 770 for the black dummy texture 730. The neural network model 750 may only output the shadow mask 760.

The electronic device may distribute and transmit the shadow mask 760 to a rendering engine 790 according to a rectangular mask region 780 occupied by a view frustum of each light so that the shadow mask 760 may be used by each light (e.g., the first light 701 and the second light 703) in the rendering engine 790. In this case, when it is possible to accurately obtain luminance attenuation for each light according to a light distance, a luminance weighted sum between different light types is also possible, so the number of light types may be minimized.

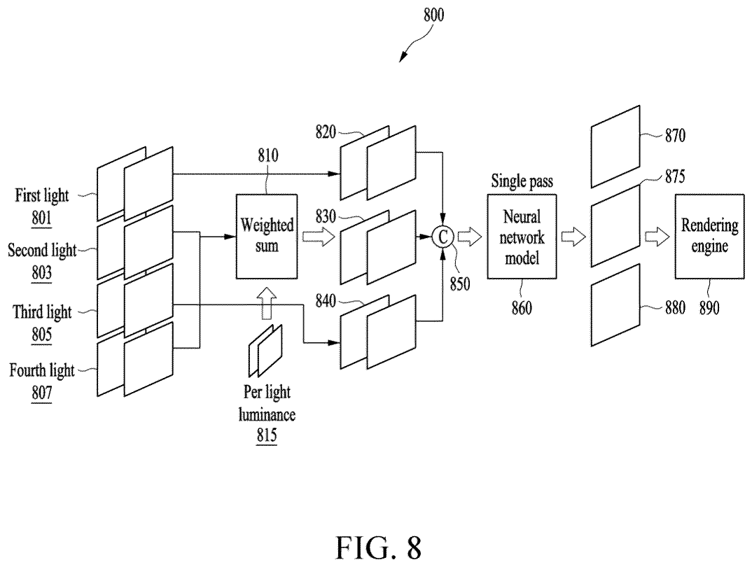

FIG. 8 is a diagram illustrating a case in which light types are input to a neural network model with the order of the light types rearranged, according to an embodiment. FIG. 8 illustrates a diagram 800 for describing an operation when a rendering scene (e.g., a current view) with three light types and four lights is input to a neural network model 860, according to an embodiment.

A camera may move during actual rendering, so depending on the view that is currently being viewed by the camera (e.g., that is currently associated with the camera), the number of lights and/or the number of light types may vary, and even when the number of lights and/or light types is the same, the order in which the lights are illuminated may be rearranged. A ray of a directional light generally reaches an object the fastest, but depending on a user setting, the directional light may not be present. Additionally, in the case of a non-directional light, the order in which the lights are illuminated may be rearranged at any time. Accordingly, the order of light types may also be rearranged.

As the order of the lights is rearranged, the order of the light types may also change, and therefore the order of the light types input to the neural network model 860 may also change. In an embodiment, the neural network model 860 may be pre-trained to be independent of the order of the lights and/or the order of the light types.

Depending on each camera view, the order of lights generated by a rendering engine 890 may be rearranged. For example, a first light type may not always be positioned first and a second light type may not always be positioned second. Therefore, the neural network model 860 should not be trained depending on the order of the lights. In an embodiment, by artificially changing the order of lights given by the rendering engine 890 during training of the neural network model 860, the neural network model 860 may adapt to the order of lights that is arbitrarily rearranged during actual rendering.

The neural network model 860 may be trained to generate shadow masks respectively corresponding to light types, regardless of the number of light types, the number of lights, or the order of the lights, depending on the view viewed by the camera in a rendered scene.

As shown in FIG. 8, the rendered scene may include a first light 801, a second light 803, a third light 805, and a fourth light 807. According to embodiments, the first light 801 may correspond to a third light type, the second light 803 may correspond to a first light type, the third light 805 may correspond to a second light type, and the fourth light 807 may correspond to the first light type. When a rendered scene corresponding to the first light 801, the second light 803, the third light 805, and the fourth light 807 is provided, the electronic device may generate one input texture 830 corresponding to the first light type using a weighted sum 810 based on luminance 815 of each of the second light 803 and the fourth light 807. In this case, because the only one light (e.g., the first light 801) corresponds to the third light type, and only one light (e.g., the third light 805) corresponds to the second light type, a rendered scene 820 corresponding to the third light type and a rendered scene 840 corresponding to the second light type may be transmitted as they are to the neural network model 860.

The electronic device may concatenate 850 the rendered scene 820 corresponding to the third light (e.g., corresponding to the first light 801), the input texture 830 corresponding to the first light type (e.g., corresponding to the second light 803 and the fourth light 807), and the rendered scene 840 corresponding to the second light type (e.g., corresponding to the third light 805) and apply the concatenated result to the neural network model 860.

Because the trained neural network model 860 may be not dependent on the order of the light types, even when the order of the lights or the order of the light types is changed, three shadow masks (e.g., a shadow mask 870 corresponding to the third light type, a shadow mask 875 corresponding to the first light type, and a shadow mask 880 corresponding to the second light type) corresponding to respective light types may be generated. The electronic device may transmit the shadow masks 870, 875, and 880 to the rendering engine 890 in the order of the light types input to the neural network model 860.

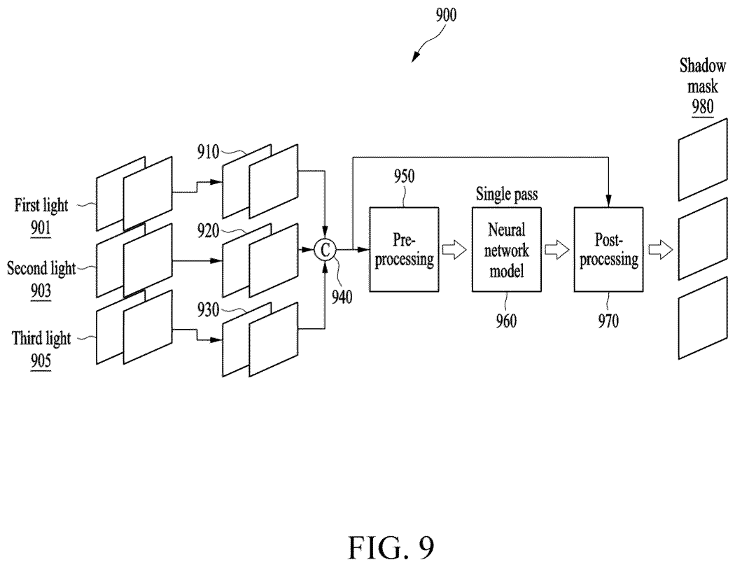

FIG. 9 is a diagram illustrating a case in which pre-processing and post-processing are performed in an electronic device, according to an embodiment. FIG. 9 illustrates a diagram 900 for describing an embodiment of performing additional processing before and after a neural network model 960, according to an embodiment.

The electronic device may perform pre-processing 950 on an input texture. The pre-processing 950 may include any pre-processing operation that enables the neural network model 960 to easily learn an original input texture such as a visibility texture or a blur radius.

The pre-processing 950 may include a linear operation and/or a non-linear operation performed per pixel on input textures 910, 920, and 930 respectively corresponding to different light types (e.g., a first light type corresponding to a first light 901, a second light type corresponding to a second light 903, and a third light type corresponding to a third light 905), a unary operation for an individual input texture for each light type, a binary operation between two input textures respectively corresponding to light types, and blurring of an input texture.

The electronic device may generate a shadow mask 980 by applying pre-processing 950 to an input texture to obtain a pre-processed input texture, and providing the pre-processed input texture to the neural network model 960. When the input texture is transformed by pre-processing 950 determined by a user, the neural network model 960 may be trained based on the transformed input texture. The pre-processing 950 may be performed after a concatenation 940 is performed on the input textures 910, 920, and 930 as illustrated in FIG. 9, or may be performed on an input texture corresponding to each light.

In addition, the electronic device may generate a shadow mask 980 corresponding to each light type by performing post-processing 970 on an output of the neural network model 960. Post-processing 970, like pre-processing 950, may also include various operations set by a user. The neural network model 960 may be trained by considering a result of the post-processing 970.

The post-processing 970 may include performing at least one of a residual path connection and kernel filtering on the output of the neural network model 960 using information before the neural network model 960 is trained. Here, the residual path may refer to a path that transmits an input passing through each layer of the neural network model 960 as it is to the next layer. Even when the depth of the neural network model 960 increases through the residual path connection, training may proceed smoothly. In addition, the kernel filtering may correspond to a process of defining an appropriate kernel or filter according to the purpose and improving the clarity of an image through a convolution operation with an original image.

As illustrated in FIG. 9, the electronic device may directly use the information before the neural network model 960 is trained during post-processing 970 of a residual path, kernel filtering, and/or the like, or may use an output of the neural network model 960 for information processed through pre-processing 950.

In general, in the neural network model 960, an input value may be transformed through multiple layers to generate an output value. However, as the depth of the layers increases, training may become more difficult. Therefore, to reduce this difficulty, the neural network model 960 may add a shortcut connection that uses identity mapping to directly transmit the input value to the next layer. This may provide a structure that generates an output value by summing an input value and a converted value, which may cause the training of the neural network model 960 to be faster and more efficient, and may maintain high accuracy without performance degradation even in a deep network.

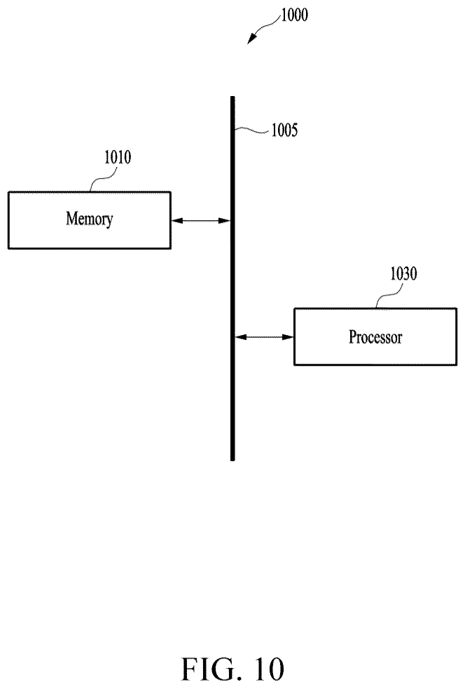

FIG. 10 is a block diagram illustrating an electronic device according to an embodiment. Referring to FIG. 10, an electronic device 1000 may include a memory 1010 and a processor 1030. The memory 1010 and the processor 1030 may be connected to one another through a communication bus 1005.

The memory 1010 may store a neural network model. The neural network model may be trained by, for example, unsupervised learning or self-supervised learning. In addition, the neural network model may include a convolutional neural network (CNN), a recurrent neural network (RNN), a perceptron, a multilayer perceptron, a feed forward (FF) network, a radial basis network (RBN), a deep feed forward (DFF) network, a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), a transformer, and an attention network (AN).

The neural network model may generally refer to a model having a problem-solving ability implemented through artificial neurons (or nodes) forming a network through synaptic connections where the strength of the synaptic connections is changed through training or machine learning. The artificial neurons of the neural network model may include a combination of weights and/or biases, and the neural network model may include one or more layers including a plurality of artificial neurons.

In addition, the memory 1010 may store instructions (or programs) executable by the processor 1030. For example, the instructions may include instructions for performing an operation of the processor 1030 and/or an operation of each component of the processor 1030.

The memory 1010 may be implemented as a volatile or non-volatile memory device. The volatile memory device may be implemented as dynamic random access memory (DRAM), static RAM (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, or insulator resistance change memory.

Based on information about lights included in a rendered scene corresponding to a view associated with (e.g., viewed by) a camera, the processor 1030 may classify the lights according to light types. The processor 1030 may generate one input texture corresponding to lights classified as the same type, based on luminance of the lights classified as the same type. The processor 1030 may generate a shadow mask for eliminating noise of a shadow corresponding to each of light types by applying the input texture to the neural network model. The processor 1030 may reduce or eliminate the shadow noise in the shadow included in a rendered scene using the shadow mask.

Also, the processor 1030 may perform one or more of the methods described with reference to FIGS. 1 through 9, or an algorithm corresponding to one or more of the methods. An algorithm may be implemented in the form of pipeline plug-in using artificial intelligence (AI), such as a neural network model, in a graphics rendering engine. In some embodiments, the algorithm may also be implemented in a mobile system on chip (SoC) including a neural processing unit (NPU).

The processor 1030 may be or may include a data processing device implemented by hardware including a circuit having a physical structure to perform desired operations. For example, the desired operations may include code or instructions in a program. The processor 1030 may be implemented as, for example, a central processing unit (CPU), a graphics processing unit (GPU), or a neural network processing unit (NPU). The processor 1030 may include, for example, a microprocessor, a CPU, a processor core, a multi-core processor, a multiprocessor, an application-specific integrated circuit (ASIC), and a field-programmable gate array (FPGA).

The processor 1030 may execute a program and control the electronic device 1000. Program code to be executed by the processor 1030 may be stored in the memory 1010.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored permanently or temporarily in any type of machine, component, physical or virtual equipment, computer storage medium, or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as ROM, RAM, flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

In the description above, although some embodiments are described with reference to the limited drawings, one of ordinary skill in the art may apply various technical modifications and variations based thereon without departing from the scope of the disclosure. For example, suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the specific examples provided above, but by the claims and their equivalents, and all variations within the scope of the claims and their equivalents are to be construed as being included in the disclosure.

What is claimed is:

1. A rendering method comprising:
based on information about a plurality of lights included in a rendered scene corresponding to a view associated with a camera, classifying the plurality of lights according to a plurality of light types;
generating an input texture corresponding to each light type from among the plurality of light types;
generating a shadow mask configured to reduce shadow noise included in a shadow corresponding to each light type by applying the input texture to a neural network model; and
reducing the shadow noise from the rendered scene using the shadow mask.

2. The rendering method of claim 1, wherein the generating of the input texture comprises, based on luminances of lights classified as a same light type from among the plurality of lights, generating a single input texture corresponding to the lights.

3. The rendering method of claim 2, wherein the generating of the input texture further comprises:
calculating luminances of the lights; and
generating the single input texture using a weighted sum based on the luminances.

4. The rendering method of claim 3, wherein the weighted sum is determined based on visibility textures and blur radius textures, and
wherein the luminances are calculated by applying, to the weighted sum, a luminance corresponding to each of the lights.

5. The rendering method of claim 3, the luminances are calculated based on a light distance corresponding to each of the lights.

6. The rendering method of claim 1, wherein a directional light is classified as corresponding to a first light type, and
wherein a non-directional light is classified as corresponding to a second light type different from the first light type.

7. The rendering method of claim 5, wherein weights of the weighted sum are assigned according to the light distance corresponding to each of the lights.

8. The rendering method of claim 1, further comprising:
determining whether a plurality of predetermined light types include a missing light type that is missing from the plurality of light types corresponding to the plurality of lights included in the rendered scene,
wherein the generating of the shadow mask comprises, based on determining that the missing light type is missing from the plurality of light types, generating a dummy output corresponding to the shadow mask and a black dummy texture corresponding to each light type by applying the black dummy texture corresponding to the missing light type to the neural network model together with the input texture.

9. The rendering method of claim 1, wherein a number of input channels included in the neural network model is proportional to a predetermined number of the plurality of light types.

10. The rendering method of claim 1, wherein the neural network model is trained to generate the shadow mask corresponding to each light type regardless of a change in at least one of a number of the plurality of light types, a number of the plurality of lights, and an order of the lights caused by a change in the view associated with the camera in the rendered scene.

11. The rendering method of claim 1, wherein the rendered scene comprises at least one of:
a visibility texture corresponding to the plurality of lights;
a blur radius texture indicating a size of a penumbra corresponding to a blur level caused by a shadow generated by the plurality of lights;
history information associated with accumulated shadow rays, wherein the history information comprises temporal information corresponding to previous frames of the rendered scene; and
light distance information corresponding to the plurality of lights.

12. The rendering method of claim 11, wherein the shadow mask is generated by applying auxiliary data to the neural network model together with the rendered scene, and
wherein the auxiliary data comprises at least one of depth information, normal information, and motion vector information.

13. The rendering method of claim 1, further comprising:
cropping the shadow mask according to a mask region corresponding to each light, and transmitting the cropped shadow mask to a rendering engine.

14. The rendering method of claim 1, wherein the plurality of light types comprise at least one of:
a directional light corresponding to sunlight; and
a non-directional light comprising at least one of a rectangular light, a spot light, and a point light corresponding to an indoor light.

15. The rendering method of claim 14, further comprising:
grouping the spot light and the point light into a first light type from among the plurality of light types; and
grouping the rectangular light into a second light type from among the plurality of light types.

16. The rendering method of claim 1, further comprising:
performing pre-processing on the input texture to obtain a pre-processed input texture,
wherein the shadow mask is generated by applying the pre-processed input texture to the neural network model.

17. The rendering method of claim 16, wherein the performing the pre-processing comprises at least one of:
performing a pixel-wise linear operation on the input texture;
performing a pixel-wise non-linear operation on the input texture;
performing a unary operation on an individual input texture for each light type;
performing a binary operation between two input textures corresponding to the plurality of light types; and
performing blurring on the input texture.

18. The rendering method of claim 16, wherein
the shadow mask is generated by performing post-processing on an output of the neural network model by performing at least one of a residual path connection and kernel filtering on the output of the neural network model.

19. A non-transitory computer-readable medium configured to store instructions which, which executed by at least one processor, cause the at least one processor to:
based on information about a plurality of lights included in a rendered scene corresponding to a view associated with a camera, classify the plurality of lights according to a plurality of light types;
generate an input texture corresponding to each light type from among the plurality of light types;
generate a shadow mask configured to reduce shadow noise in a shadow corresponding to each light type by applying the input texture to a neural network model; and
reduce the shadow noise in the rendered scene using the shadow mask.

20. An electronic device, comprising:
a memory configured to store a neural network model; and
at least one processor configured to:
based on information about a plurality of lights included in a rendered scene corresponding to a view associated with a camera, classify the plurality of lights according to a plurality of light types;
based on luminances of lights classified as a same light type from among the plurality of lights, generate an input texture corresponding to each light type from among the plurality of light types;
generate a shadow mask configured to reduce shadow noise in a shadow corresponding to each light type by applying the input texture to the neural network model; and
reduce the shadow noise in the rendered scene using the shadow mask.
